(19) United States
(12) Patent Application Publication
(10) Pub. No.: US 2025/0053011 A1
(43) Pub. Date: Feb. 13, 2025

(54) MULTI-INPUT IMAGE LIGHT GUIDE SYSTEM

(71) Applicant: Vuzix Corporation, West Henrietta, NY (US)

(72) Inventor: Robert J. Schultz, Victor, NY (US)

(21) Appl. No.: 18/723,457

(22) PCT Filed: Dec. 22, 2022
(86) PCT No.: PCT/US2022/053865

§ 371 Date: Jun. 23, 2024

Related U.S. Application Data
(60) Provisional application No. 63/293,112, filed on Dec. 23, 2021.

(51) Int. Cl. G02B 27/01; F21V 8/00; G02B 27/00

(52) U.S. Cl. CPC G02B 27/0172; G02B 6/0016; G02B 6/0036; G02B 6/0076; G02B 27/0081; G02B 2027/0125; G02B 2027/0174

(57) ABSTRACT

An image light guide system for conveying a virtual image including a first waveguide and a second waveguide. A first in-coupling diffractive optic formed along the first waveguide and operable to diffract a first set of image-bearing light beams into the first waveguide in an angularly encoded form. A second in-coupling diffractive optic formed along the first waveguide and operable to diffract a second set of image-bearing light beams into the first waveguide in an angularly encoded form. A first out-coupling diffractive optic formed along the first waveguide and operable to expand at least a portion of the first and second sets of image-bearing light beams and direct the expanded image-bearing light beams from the first waveguide in an angularly decoded form. A first intermediate diffractive optic formed along the first waveguide and operable to direct the second set of image-bearing light beams to the first out-coupling diffractive optic. A third in-coupling diffractive optic formed along the second waveguide and operable to diffract a third set of image-bearing light beams into the second waveguide in an angularly encoded form.

### TECHNICAL FIELD

The present disclosure relates generally to electronic displays, and more particularly to optical image light guide systems with diffractive optics to convey image-bearing light to a viewer.

### BACKGROUND

Head-Mounted Displays (HMDs) are being developed for a range of diverse uses, including military, commercial, industrial, fire-fighting, and entertainment applications. For many of these applications, there is value in forming a virtual image that can be visually superimposed over the real-world image that lies in the field of view of the HMD user. An optical image light guide may convey image-bearing light to a viewer in a narrow space for directing the virtual image to the viewer's pupil and enabling this superposition function.

In conventional image light guide arrangements, collimated, relatively angularly encoded light beams from an image source are coupled into a planar waveguide by an input coupling such as an in-coupling diffractive optic, which can be mounted or formed on one or more of the surfaces of the planar waveguide and/or buried within the waveguide. Such diffractive optics can be formed as diffraction gratings, holographic optical elements or in other known ways. For example, a diffraction grating can be formed by surface relief. After propagating along the waveguide, image-bearing light can be directed back out of the waveguide by an output coupling optic such as an out-coupling diffractive optic, which can be arranged to provide pupil expansion in one or more directions.

Stacked waveguides may be used to form multiple light paths to convey image information. For example, multiple light paths may be utilized to propagate image-bearing light of different wavelength ranges to the eyebox. Diffractive optics may require different properties for optimal performance of each wavelength range, such as red (R), green (G), and blue (B) wavelength ranges. However, there are still issues to resolve. For example, one wavelength range or angular relationship may be coupled into a planar waveguide by an in-coupling optic less efficiently than other wavelength ranges or angular relationships. Further, while the in-coupling efficiency of one wavelength range or angular relationship may be enhanced by having an additional in-coupling optic for such wavelength range or angular relationship, this can lead to crosstalk in a waveguide system. Crosstalk can lead to disparities between the color image data and the displayed color, and can also be a cause of objectionable color shifts, perceptible across the image field. Also, if an in-coupled ray is reflected (i.e., bounces by total internal reflection) onto an in-coupling diffractive optic, the in-coupled ray tends to out-couple, resulting in a reduced quantity (i.e., intensity) of image-bearing light input to the image-light guide propagating through the waveguide. Thus, it can be appreciated that there is a need for a polychromatic image light guide system operable to produce the desired virtual image with enhanced brightness, resolution and color balance.

### SUMMARY

It is an object of the present disclosure to advance the art of near eye display systems. Advantageously, embodiments of the present disclosure provide stacked waveguides having multiple diffractive optics positioned to provide each wavelength range or angular relationship of image-bearing light to be coupled into the planar waveguides by different in-coupling elements (e.g., diffraction gratings). The intensity of one wavelength range or angular relationship of image-bearing light may be enhanced by having more than one in-coupling element for such wavelength range or angular relationship.

In a first exemplary embodiment of the present disclosure, there is provided an image light guide system for conveying a virtual image including a first planar waveguide and a second planar waveguide, each of the first and second planar waveguides operable to propagate image-bearing light beams and each having first and second surfaces. A first in-coupling diffractive optic formed along the first planar waveguide, the first in-coupling diffractive optic operable to diffract a first set of image-bearing light beams into the first planar waveguide in an angularly encoded form. A second in-coupling diffractive optic formed along the first planar waveguide, the second in-coupling diffractive optic operable to diffract a second set of image-bearing light beams into the first planar waveguide in an angularly encoded form. A first out-coupling diffractive optic formed along the first planar waveguide, the first out-coupling diffractive optic operable to expand at least a portion of the first and second sets of image-bearing light beams and direct the expanded image-bearing light beams from the first waveguide in an angularly decoded form. A first intermediate diffractive optic formed along the first planar waveguide, the first intermediate diffractive optic operable to direct the second set of image-bearing light beams to the first out-coupling diffractive optic. A third in-coupling diffractive optic formed along the second planar waveguide, the third in-coupling diffractive optic operable to diffract a third set of image-bearing light beams into the second planar wave-guide in an angularly encoded form.

In a second exemplary embodiment of the present disclosure, there is provided an image light guide system for conveying a virtual image, comprising a first and a second planar waveguide, each of said first and second planar waveguides operable to propagate image-bearing light beams, said first and second planar waveguides each having first and second parallel surfaces, wherein said first parallel surface of said first planar waveguide is an inner surface facing said second planar waveguide, and wherein said first parallel surface of said second planar waveguide is an inner surface facing said first planar waveguide, a first in-coupling diffractive optic formed along said inner surface of said first planar waveguide and disposed to direct image-bearing light beams into said first planar waveguide, wherein said first in-coupling diffractive optic comprises a first plurality of diffractive structures having a first periodicity and is operable to diffract a first portion of said image-bearing light beams into said first planar waveguide in an angularly encoded form, a second in-coupling diffractive optic formed along said inner surface of said first planar waveguide and disposed to direct image-bearing light beams into said first planar waveguide, wherein said second in-coupling diffractive optic comprises a second plurality of diffractive structures having a second periodicity different from said first periodicity and is operable to diffract a second portion of said image-bearing light beams into said first planar waveguide in an angularly encoded form, a first out-coupling diffractive optic formed along said inner surface of said first waveguide, wherein said first out-coupling diffractive optic is operable to expand said first portion and said second portion of said image-bearing light beams and direct said expanded first portion and said expanded second portion of said image-bearing light beams from said first waveguide in an angularly decoded form, a first intermediate diffractive optic formed along said inner surface of said first waveguide and operable to direct said second portion of said image-bearing light beams to said first out-coupling optic, a third in-coupling diffractive optic formed along said first inner surface of said second planar waveguide and disposed to direct image-bearing light beams into said second planar waveguide, wherein said third in-coupling diffractive optic comprises a third plurality of diffractive structures having a third periodicity and is operable to diffract said first portion of said image-bearing light beams into said second planar waveguide in an angularly encoded form; and a fourth in-coupling diffractive optic formed along said inner surface of said second planar waveguide and disposed to direct image-bearing light beams into said second planar waveguide, wherein said fourth in-coupling diffractive optic comprises a fourth plurality of diffractive structures having a fourth periodicity different from said third periodicity and is operable to diffract a third portion of said image-bearing light beams into said second planar waveguide in an angularly encoded form.

### BRIEF DESCRIPTION OF THE DRAWINGS

The accompanying drawings are incorporated herein as part of the specification. The drawings described herein illustrate embodiments of the presently disclosed subject matter and are illustrative of selected principles and teachings of the present disclosure. However, the drawings do not illustrate all possible implementations of the presently disclosed subject matter and are not intended to limit the scope of the present disclosure in any way.

FIG. 1 shows a perspective front view of an image light guide assembly having a stack of planar waveguides, including a first and second planar waveguide, each planar waveguide having diffractive optical elements according to an embodiment of the present disclosure.

FIG. 2A shows a first side view of the image light guide system according to FIG. 1.

FIG. 2B shows a second side view of the image light guide system according to FIG. 1.

FIG. 3 shows a perspective back view of the first planar waveguide according to FIG. 1.

FIG. 4 shows a perspective front view of the second waveguide according to FIG. 1.

FIG. 5 shows a back view of the first planar waveguide according to FIG. 1.

FIG. 6 shows an enlarged view of the first out-coupling diffractive optic according to an embodiment of the present disclosure.

FIG. 7 shows a front view of the second planar waveguide having diffractive optical elements, each having a plurality of diffractive structures according to an embodiment of the present disclosure.

FIG. 8 shows an enlarged view of the second out-coupling diffractive optic according to an embodiment of the present disclosure.

### DETAILED DESCRIPTION

It is to be understood that the invention may assume various alternative orientations and step sequences, except where expressly specified to the contrary. It is also to be understood that the specific assemblies and systems illustrated in the attached drawings and described in the following specification are simply exemplary embodiments of the inventive concepts defined herein. Hence, specific dimensions, directions, or other physical characteristics relating to the embodiments disclosed are not to be considered as limiting, unless expressly stated otherwise. Also, although they may not be, like elements in various embodiments described herein may be commonly referred to with like reference numerals within this section of the application.

As used herein, the terms “first,” “second,” and so on, do not necessarily denote any ordinal, sequential, or priority relation, but are simply used to more clearly distinguish one element or set of elements from another, unless specified otherwise.

As used herein, the terms “front,” “back,” “side,” and so on, do not necessarily denote any ordinal, sequential, spatial, or priority relation, but are simply used to more clearly distinguish one element or set of elements from another, unless specified otherwise.

As used herein, the term “exemplary” is meant to denote “an example of,” and is not intended to suggest any preferred or ideal embodiment.

As used herein, the term “set” refers to a non-empty set, as the concept of a collection of elements or members of a set is widely understood in elementary mathematics. As used herein, the term “subset”, unless otherwise explicitly stated, is used herein to refer to a non-empty proper subset, that is, to a subset of the larger set, having one or more members. For a set S, a subset may comprise the complete set S. A “proper subset” of set S, however, is strictly contained in set S and excludes at least one member of set S.

As used herein, the terms “wavelength band” and “wavelength range” are equivalent and have their standard connotation as used by those skilled in the art of color imaging and refer to a continuous range of light wavelengths that are used to represent polychromatic images.

As used herein, the term “coupled” is intended to indicate a physical association, connection, relation, or linking, between two or more components, such that the disposition of one component affects the spatial disposition of a component to which it is coupled. For mechanical coupling, two components need not be in direct contact, but can be linked through one or more intermediary components. A component for optical coupling allows light energy to be input to, or output from, an optical apparatus as understood by those skilled in the art.

As used herein, the term “beam expansion” is intended to mean replication of a beam via multiple encounters with an optical element to provide exit pupil expansion in one or more directions. Similarly, as used herein, to “expand” a beam, or a portion of a beam, is intended to mean replication of a beam via multiple encounters with an optical element to provide exit pupil expansion in one or more directions.

A HMD is operable to form a virtual color image that can be visually superimposed over the real-world image that lies in the field of view of the HMD user. Optically transparent parallel plate waveguides, also called planar waveguides, convey image-bearing light generated by a color projector system to the HMD user. The planar waveguides convey the image-bearing light in a narrow space to direct the virtual image to the HMD user's pupil and enable the superposition of the virtual image over the real-world image that lies in the field of view of the HMD user.

In image light guides, collimated, relatively angularly encoded light beams from a color image projector source are coupled into an optically transparent image light guide assembly by an input coupling optic, such as an in-coupling diffractive optic, which can be mounted or formed on a surface of the parallel plate planar waveguide or disposed within the waveguide. Such diffractive optics can be formed as, but are not limited to, diffraction gratings or holographic optical elements. For example, the diffraction grating can be formed as a surface relief grating. After propagating along the planar waveguide, the diffracted color image-bearing light can be directed back out of the planar waveguide by a similar output grating, which may be arranged to provide pupil expansion along one or more directions. In addition, one or more diffractive turning gratings may be positioned along the waveguide optically between the input and output gratings to provide pupil expansion in one or more directions. The image-bearing light output from the parallel plate planar waveguide provides an expanded eyebox for the viewer.

An optical system, such as a HMD, can produce a virtual image. In contrast to methods for forming a real image, a virtual image is not formed on a display surface. That is, if a display surface were positioned at the perceived location of a virtual image, no image would be formed on that surface. Virtual images have a number of inherent advantages for augmented reality presentation. For example, the apparent size of a virtual image is not limited by the size or location of a display surface. Additionally, the source object for a virtual image may be small; for example, a magnifying glass provides a virtual image of an object. In comparison with systems that project a real image, a more realistic viewing experience can be provided by forming a virtual image that appears to be some distance away. Providing a virtual image also obviates the need to compensate for screen artifacts, as may be necessary when projecting a real image.

A generally planar optical waveguide is a physical structure that may be used to convey image-bearing optical light from one region of the waveguide to other regions of the waveguide. Applications for such image conveying waveguides include head mounted monocular or binocular display systems.

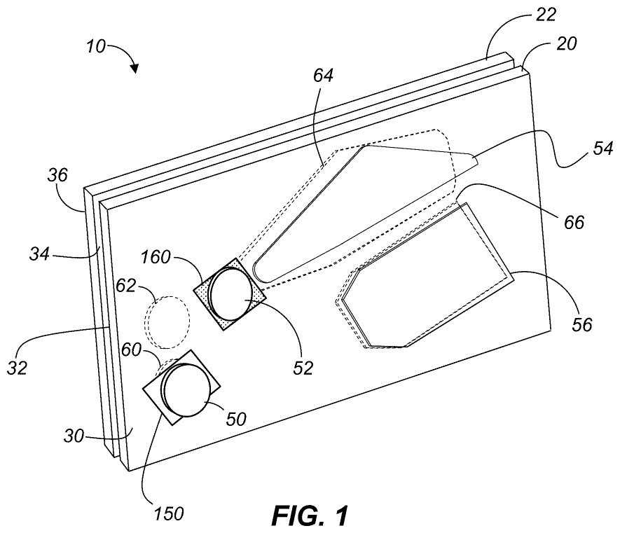

As illustrated in FIG. 1, in an embodiment, an image light guide assembly 10 includes a first planar waveguide 20 and a second planar waveguide 22. First planar waveguide 20 and second planar waveguide 22 comprise a transparent material. Image-bearing light emitted from an image source, for example an LED projector, can be in-coupled into the first and/or second waveguide 20, 22, wherein the light propagates through the waveguide 20, 22 by total internal reflection. The first planar waveguide 20 has parallel front planar surface 30 and back planar surface 32. The second planar waveguide 22 also includes a front planar surface 34 and a back planar surface 36 parallel to front planar surface 34. The first planar waveguide 20 includes a first in-coupling diffractive optic 50 and a second in-coupling diffractive optic 52, each located in/on the back planar surface 32. In this embodiment, where the back planar surface 32 of the first planar waveguide 20 faces the front planar surface 34 of the second planar waveguide 22, the back planar surface 32 forms an inner surface of the image light guide assembly 10. In an embodiment, the in-coupling diffractive optics 50, 52 each comprise a surface relief grating. In another embodiment, the in-coupling diffractive optics 50, 52 each comprise a holographic optical element. The first planar waveguide 20 may also include an intermediate diffractive optic 54 and an out-coupling diffractive optic 56 each located on the back planar surface 32. The intermediate diffractive optic 54 is oriented to diffract a portion of the image-bearing light toward the out-coupling diffractive optic 56 as described in more detail below. The intermediate diffractive optic 54 may be referred to herein as a turning grating. In an embodiment, the turning grating 54 is a surface relief grating. In another embodiment, the turning grating 54 is a holographic optical element. The turning grating 54 is operable to replicate and turn a portion of image-bearing light beams traveling within the first planar waveguide 20 in one or more directions or dimensions, providing pupil expansion in one or more directions or dimensions.

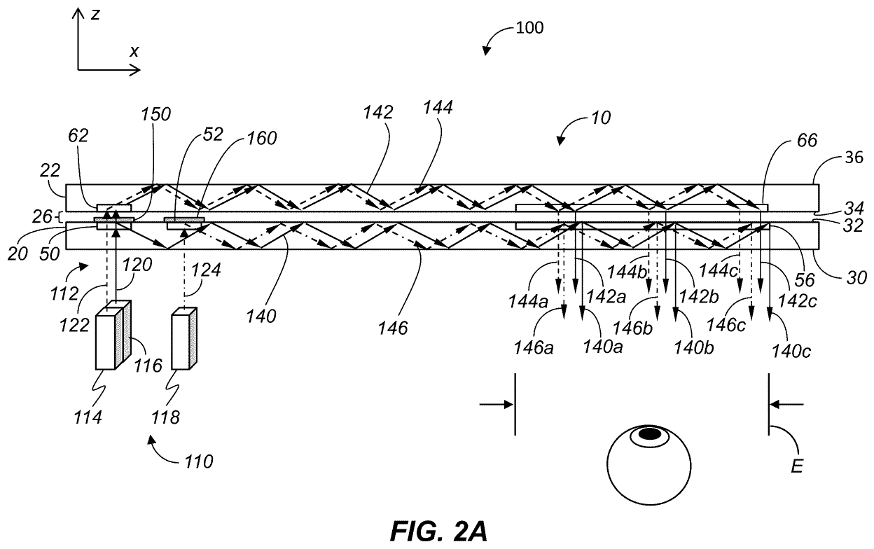

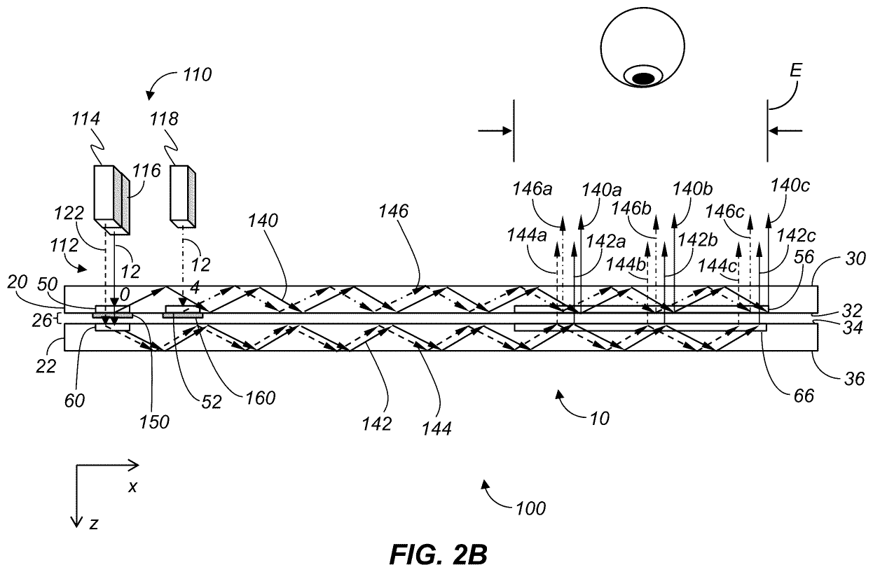

Continuing to refer to FIG. 1, the out-coupling diffractive optic 56 is operable to diffract a portion of the image-bearing light beams propagating within the first planar waveguide 20 out of the first planar waveguide 20. In an embodiment, the out-coupling diffractive optic 56 is a surface relief grating. In another embodiment, the out-coupling diffractive optic 56 is a holographic optical element. The out-coupling diffractive optic 56 may be arranged to provide pupil expansion in one or more directions or dimensions. For example, in one embodiment, image-bearing light beams are first diffracted by in-coupling diffractive optics 50, 52 providing in-coupled image-bearing light beams. The in-coupled image-bearing light beams comprise a range of angularly related beams that propagate through the first planar waveguide 20 by Total Internal Reflection (TIR) between the front planar surface 30 and the back planar surface 32 of the first planar waveguide 20. The out-coupling diffractive optic 56, having refractive index variations along at least a single direction or dimensions can expand one direction of the eyebox E (see FIGS. 2A and 2B) by replicating the individual angularly related beams in their direction of propagation along the first planar waveguide 20 by multiple encounters with the out-coupling diffractive optic 56. To increase one or more directions of overlap among the angularly related beams in the so-called eyebox E within which the virtual image can be seen, the out-coupling diffractive optic 56 is arranged to encounter the image-bearing light multiple times and to diffract only a portion of the image-bearing light on each encounter. The multiple encounters along the length of the out-coupling optic in the direction of propagation have the effect of expanding one direction of the eyebox E within which the image-bearing light beams overlap. The expanded eyebox E decreases sensitivity to the position of a viewer's eye for viewing the virtual image.

As provided above, the second planar waveguide 22 includes the front planar surface 34 and the back planar surface 36 parallel to front planar surface 34. In an embodiment, the second waveguide 22 includes a first in-coupling diffractive optic 60 and a second in-coupling diffractive optic 62, each located on/in the front planar surface 34. In this embodiment, where the front planar surface 34 of the second planar waveguide 22 is adjacent to the back planar surface 32 of the first planar waveguide 20, the front planar surface 34 forms an inner surface of the image light guide assembly 10. In an embodiment, the in-coupling diffractive optics 60, 62 each comprise a surface relief grating. In another embodiment, the in-coupling diffractive optics 60, 62 each comprise a holographic optical element. In another embodiment, one of the in-coupling diffractive optics 60, 62 is a surface relief grating and the other one of the in-coupling diffractive optics 60, 62 is a holographic optical element.

The second planar waveguide 22 may further include an intermediate diffractive optic 64 and an out-coupling diffractive optic 66, each located on/in the front planar surface 34. The intermediate diffractive optic 64 is oriented to diffract a portion of the image-bearing light toward the out-coupling diffractive optic 66. The intermediate diffractive optic 64 may be referred to herein as a turning grating. In an embodiment, the turning grating 64 is a surface relief grating. In another embodiment, the turning grating 64 is a holographic optical element. The turning grating 64 is operable to expand an image-bearing light beam traveling within the second waveguide 22 in one or more directions or dimensions providing pupil expansion in one or more directions or dimensions. The out-coupling diffractive optic 66 is operable to diffract a portion of the image-bearing light beams propagating within the second planar waveguide 22 out of the second planar waveguide 22. In an embodiment, the out-coupling diffractive optic 66 is a surface relief grating. In another embodiment, the out-coupling diffractive optic 66 is a holographic optical element. The out-coupling diffractive optic 66 may be arranged to encounter image-bearing light beams multiple times to provide pupil expansion in one or more directions or dimensions. For example, in one embodiment, image-bearing light beams are first diffracted by in-coupling diffractive optics 60, 62 providing in-coupled image-bearing light beams. The in-coupled image-bearing light beams comprise a range of angularly related beams that propagate through the second planar waveguide 22 by TIR between the front planar surface 34 and the back planar surface 36 of the second planar waveguide 22. The out-coupling diffractive optic 66, having refractive index variations along at least a single direction or dimensions can expand at least one direction of the eyebox E by replicating the individual angularly related beams in their direction of propagation along the second planar waveguide 22 between encounters with the out-coupling diffractive optic 66. In an embodiment, the in-coupling diffractive optic 62 and the turning grating 64 may not be included as part of the image light guide assembly 10.

Further, as shown in FIG. 1, the first intermediate diffractive optic 54 may at least partially overlap the second intermediate diffractive optic 64, but is not directly aligned over the second intermediate diffractive optic 64. Typically, the intermediate diffractive optics 54, 64 are shaped to maximize the amount of in-coupled image-bearing light beams that reach the out-coupling diffractive optics 56, 66, respectively. In one embodiment, the intermediate diffractive optics 54, 64 are shaped such that image-bearing light beams 144 and 146 (see FIG. 2B) reach all four corners of the out-coupling diffractive optics, 56, 66, respectively. Thus, the intermediate diffractive optics 54, 64 may have different shapes.

Turning now to FIGS. 2A and 2B, an image light guide system 100 includes the image light guide assembly 10 and further includes an image source 110 that produces at least one image-bearing light beam 112. FIGS. 2A and 2B show opposite sides of the image light guide assembly 10 as rotated about the (horizontal) x-axis. In an embodiment, image source 110 is a pico-projector. For example, the image source 110 may be a pico-projector that produces a single primary color band, (red, green, or blue), of the image to be presented to a viewer looking generally along z-axis direction through the planar waveguide assembly 10. In another embodiment, the image source 110 is a pico-projector that produces three primary color bands (red, green, or blue). The three primary color bands in one embodiment are a green band having a wavelength in the range between 500 nm and 565 nm, a red band having a wavelength in the range between 615 nm and 740 nm, and a blue band having a wavelength in the range between 450 nm and 485 nm. As shown in FIGS. 2A and 2B, in an embodiment, the image source 110 is a set of pico-projectors 114, 116, 118, wherein the first pico-projector 114 produces green light, the second pico-projector 116 produces red light, and the third pico-projector 118 produces blue light. Image source 110 may be positioned such that a central ray of the image-bearing light beam 112 is generally perpendicular to the first planar waveguide 20 front surface 30. Image source 110 may also be positioned such that a central ray of the image-bearing light beam 112 is not perpendicular to the first planar waveguide 20 front surface 30.

In an embodiment, a portion of an image-bearing light beam 120 is diffracted into the first planar waveguide 20 by in-coupling diffractive optic 50 as in-coupled image-bearing light beam 140 and a portion of the image-bearing light beam 120 passes through the first planar waveguide 20 to the in-coupling diffractive optic 60 (see FIG. 2B) of the second planar waveguide 22 where a portion of the image-bearing light beam 120 is diffracted into the second planar waveguide 22 as in-coupled image-bearing light beam 142. The in-coupled light beam 140 propagates through the first planar waveguide 20 by TIR between front planar surface 30 and back planar surface 32 of the first planar waveguide 20. The in-coupled light beam 142 propagates through the second planar waveguide 22 by TIR between front planar surface 34 and back planar surface 36. In-coupled image-bearing light beam 140 may be directed out of the first planar waveguide 20 by the out-coupling diffractive optic 56 as out-coupled image-bearing light beams 140a, 140b, 140c. In-coupled image-bearing light beam 142 may be directed out of the second planar waveguide 22 by the out-coupling diffractive optic 66 as out-coupled image-bearing light beams 142a, 142b, 142c.

With continued reference to FIGS. 2A and 2B, in-coupling diffractive optic 50 may be positioned on back planar surface 32 of the first planar waveguide 20. In another embodiment, in-coupling diffractive optic 50 is positioned on the front planar surface 30 of the first planar waveguide 20. In an embodiment, the in-coupling diffractive optic 50 is overlapping and co-axial with in-coupling diffractive optic 60. In an embodiment the out-coupling diffractive optic 56 is positioned on the back planar surface 32 of the first waveguide 22 and the out-coupling diffractive optic 66 is positioned on the front planar surface 34 of the second waveguide 22. The out-coupling diffractive optic 56 may be overlapping and aligned with out-coupling diffractive optic 66. In another embodiment, the out-coupling diffractive optics 56, 66 are positioned on the outer surfaces of the planar waveguides 20, 22, that is, front planar surface 30 of the first planar waveguide 20 and the back planar surface 36 of the second planar waveguide 22, respectively. In yet another embodiment, one of the out-coupling diffractive optics 56, 66 is positioned on the outer surface of one of the planar waveguides 20, 22 and the other out-coupling diffractive optic is positioned on the inner surface of the other planar waveguide 20, 22. As discussed in more detail below, a waveplate 150 is located optically between the in-coupling optic 50 of the first planar waveguide 20 and in-coupling optic 60 of the second planar waveguide 22.

As illustrated in FIGS. 2A and 2B, in an embodiment, the image-bearing light beam 122 passes through the first planar waveguide 22 to the in-coupling diffractive optic 62 of the second planar waveguide 22 where at least a portion of the image-bearing light beam 122 is diffracted into the second planar waveguide 22 as in-coupled image-bearing light beam 144. The in-coupled image-bearing light beam 144 propagates through the second planar waveguide 22 by TIR between front planar surface 34 and back planar surface 36. In-coupled image-bearing light beam 144 may be redirected by the turning grating 64 and may be expanded in at least one direction or dimensions and directed out of the second planar waveguide 22 by the out-coupling diffractive optic 66 as out-coupled image-bearing light beams 144a, 144b, 144c.

With continued reference to FIGS. 2A and 2B, in an embodiment, the in-coupling diffractive optic 62 and the turning grating 64 (shown in FIG. 1) are positioned on the front planar surface 34 of the second planar waveguide 22. In another embodiment, the in-coupling diffractive optic 62 and the turning grating 64 are positioned on the back planar surface 36 of the second planar waveguide 22. It should be appreciated that, by having the diffractive optics 60, 62, 64, 66 on an inner surface, that is, on the inner or front surface 34 of the second waveguide 22, the diffractive optics are more protected from environmental or usage damage.

In an embodiment, the image-bearing light beam 124 is diffracted into the first planar waveguide 20 as in-coupled image-bearing light beam 146. The in-coupled image-bearing light beam 146 propagates through the first planar waveguide 20 by TIR between front planar surface 30 and back planar surface 32. In-coupled image-bearing light beam 146 may be redirected by the turning grating 54 and may be expanded in at least one direction or dimension and may be directed out of the first planar waveguide 20 by the out-coupling diffractive optic 56 as out-coupled image-bearing light beams 146a, 146b, 146c.

With continued reference to FIGS. 2A and 2B, in an embodiment, the in-coupling diffractive optic 52 and the turning grating 54 (shown in FIG. 1) are positioned on the back planar surface 32. In another embodiment, the in-coupling diffractive optic 52 and the turning grating 54 are positioned on the front planar surface 30. It should be appreciated that, by having the diffractive optics 50, 52, 54, 56 on an inner surface, that is, on the inner or back surface 32 of the first waveguide 20, the diffractive optics are more protected from environmental or usage damage.

A gap 26 separates the first planar waveguide 20 from the second planar waveguide 22. In an embodiment, the gap 26 comprises substantially air. In another embodiment, the gap 26 comprise nitrogen. In another embodiment, the gap 26 comprise an inert gas. In yet another embodiment, the gap 26 comprise a low index of refraction material.

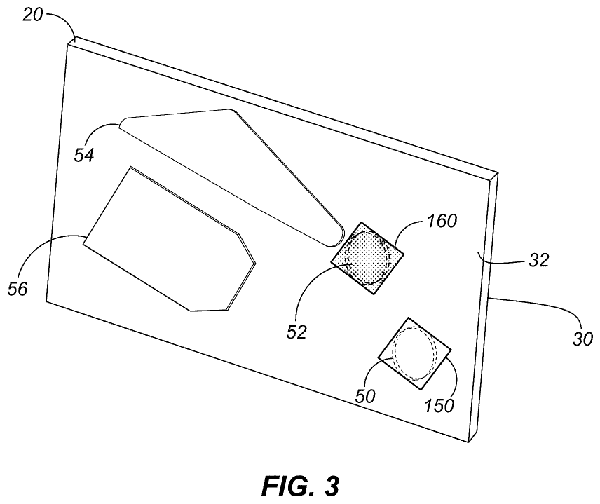

FIG. 3 is a perspective view of the back of the first planar waveguide 20 having diffractive optics 50, 52, 54, and 56, and a waveplate 150. The waveplate 150 is positioned optically between the in-coupling optic 50 of the first planar waveguide 20 and the in-coupling optic 60 of the second planar waveguide 22. The length of the waveplate 150 is sized so that it does not overlie in-coupling optic 62 and further is greater or equal to the diameter of the in-coupling diffractive optics 50, 60. The waveplate 150 is operable to turn the polarization direction of the image-bearing light 120 (shown in FIG. 2A) such that the image light guide system 100 takes full advantage of the image-bearing light from the image source 110, for example, from projector 116. For example, the waveplate 150 may be a half-wave waveplate operable to rotate the polarization direction of the image-bearing light orthogonal (90°) or nearly orthogonal.

In an embodiment, the waveplate 150 may be a quarter-wave waveplate operable to rotate the polarization direction of the image-bearing light generally forty-five degrees (45°). In one embodiment, the quarter-wave waveplate is operable to rotate the polarization direction of the image-bearing light in the range of approximately 20 degrees (20°) to 45 degrees (45°). In yet another embodiment, two quarter waveplates are included to rotate the polarization of the beams by 90 degrees (90°).

Transmissive-type diffraction gratings have lower polarization sensitivity than reflective-type diffraction gratings. Where the second in-coupling diffractive optic 60 is a reflective-type diffraction grating, polarization of the image-bearing light via the waveplate 150 enables a greater diffraction efficiency. For example, rotating the portion of the image-bearing light beam 120 that is incident on the second in-coupling diffractive optic 60 increases the intensity of the in-coupled image-bearing light because surface relief gratings have a higher diffraction efficiency when s-polarized light is aligned with the linear diffractive features. In an embodiment, the image source 110 is a color field sequential projector system operable to pulse image-bearing light of red, green, and blue wavelength ranges onto a digital light modulator/micro-mirror array (a “DLP”) or a liquid crystal on silicon (“LCOS”) display.

Conventional image light guides often struggle to achieve a desirable brightness of image-bearing light in the red wavelength range directed to the eyebox E. For example, the red arrays in current μLED displays are difficult to produce with an efficiency equivalent to blue and green arrays. By utilizing two optical paths for image-bearing light of the red wavelength range the intensity of the image-bearing light in the red wavelength range can be increased. However, p LED and DLP systems are un-polarized, and even image-bearing light from polarized light sources is often scrambled by polymer optics in image magnification. By aligning the s-polarization of the image-bearing light incident upon the second in-coupling diffractive optic 60 via the waveplate 150, the present disclosure provides an apparatus operable to optimize diffraction efficiency and the intensity of the in-coupled red wavelength image-bearing light while reducing power requirements at the image source. Further, the use of two in-coupling diffractive optics 50, 60, one on each waveguide 20, 22, for image-bearing light in the red wavelength range is operable to militate against crosstalk between waveguides and color paths.

As illustrated in FIG. 3, the first planar waveguide 20 includes the first in-coupling diffractive optic 50, the second in-coupling diffractive optic 52, turning grating 54, and the first out-coupling diffractive optic 56, each located on/in the back planar surface 32. An absorptive layer 160 may be located optically between the in-coupling diffractive optic 52 and the second intermediate diffractive optic 64. For example, the absorptive layer 160 may be located generally over the second in-coupling diffractive optic 52 on the back surface 32 of the first waveguide 20. In an embodiment, the absorptive layer 160 is operable to prevent image-bearing light 124 from reaching the second intermediate diffractive optic 64 on the second waveguide 22. Without the absorptive layer 160, image-bearing light 124 may otherwise pass through the first planar waveguide 20 to the intermediate diffractive optic 64 of the second planar waveguide 22 where a portion of the image-bearing light 124 may be diffracted into the second planar waveguide 22 as undesired, out of sequence, in-coupled image-bearing light. That is, the absorptive layer 160 is provided to reduce crosstalk by blocking a portion of image-bearing light 124. Thus, the image-bearing light 124 has a separate optical path from image-bearing light 120 and image-bearing light 122 within the image light guide assembly 10, so that “leakage” of light to the wrong color path or angular range does not occur or is negligible.

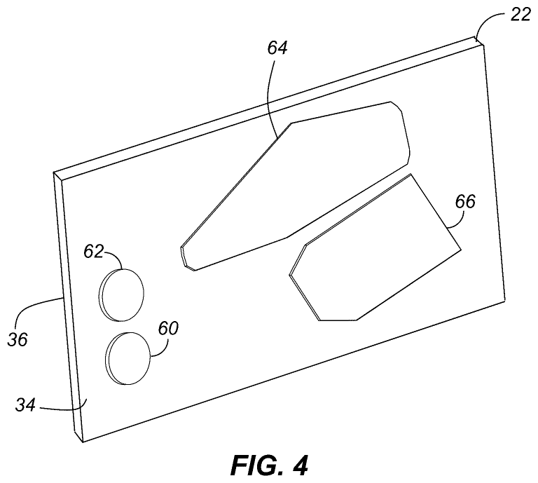

FIG. 4 shows a perspective view of the second planar waveguide 22 having the third in-coupling diffractive optic 60 and the fourth in-coupling diffractive optic 62, the second turning grating 64, and the second out-coupling diffractive optic 66, each located on the front planar surface 34 thereof. In an embodiment, a possible shape of the intermediate diffractive optic 64 and the out-coupling diffractive optic 66 is shown.

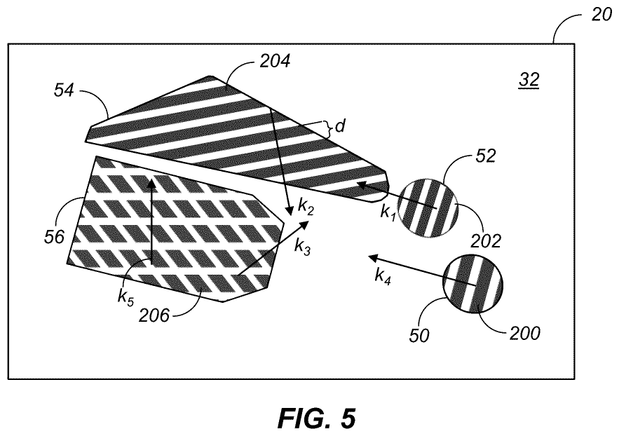

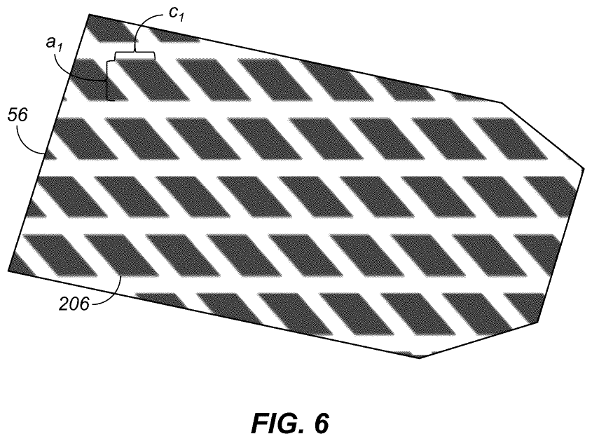

FIG. 5 shows a back view the first planar waveguide 20. In an embodiment, the in-coupling diffractive optic 50 includes diffractive features 200 having an associated grating vector k₄, and the in-coupling diffractive optic 52 includes diffractive features 202 having an associated grating vector k₁. The first intermediate diffractive optic 54 includes diffractive features 204 having an associated grating vector k₂, and the out-coupling diffractive optic 56 includes diffractive features 206 having associated grating vectors k₃ and k₅. As illustrated in FIG. 5, in an embodiment, the out-coupling diffractive optic 56 includes a plurality of diffractive features creating a compound diffractive pattern. The compound diffractive pattern may be represented by at least two grating vectors k₃, k₅. In an embodiment, as shown in FIG. 6, the diffractive features 206 have a length (a₁) of approximately 409 nm and a length (c₁) of approximately 480 nm. In an embodiment, the out-coupling diffractive optic 56 is operable to provide pupil expansion in at least two directions or dimensions.

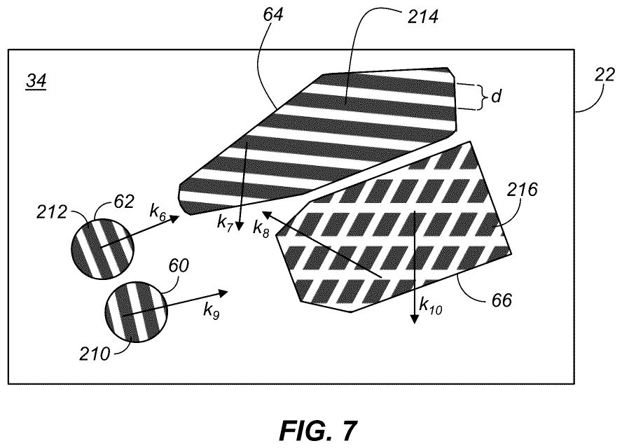

Grating vectors, such as the depicted grating vectors k₁, k₂, k₃, k₄, and k₅ as shown in FIG. 5 extend in a direction that is normal to the diffractive features (e.g., grooves, lines, or rulings) and have a magnitude related to the inverse to the period or pitch d (i.e., the on-center distance between grooves) of the diffractive optics. The in-coupling optics 50, 52 and the intermediate diffractive optic 54 may each have a different period or pitch d. In one embodiment, the in-coupling diffractive optic 50 has a pitch of approximately 480 nm, the in-coupling diffractive optic 52 has a pitch of approximately 341 nm, and the intermediate diffractive optic 54 has a pitch of approximately 330 nm. In an embodiment, combinations of grating vectors ±k₁, ±k₂, and ±k₃ form a vector triangle when placed tip to tail. In one embodiment, the triangle is an equilateral triangle. In one embodiment, the triangle is an isosceles triangle. In one embodiment, the triangle is a scalene triangle. In an embodiment, combinations of grating vectors ±k₄, ±k₅, and ±k₁₀ (shown in FIG. 7) form a vector triangle when placed tip to tail. In one embodiment, the triangle is an equilateral triangle. In one embodiment, the triangle is an isosceles triangle. In one embodiment, the triangle is a scalene triangle. In an embodiment, the in-coupling diffractive optic 50 and the out-coupling diffractive optic 56 provide an optical path for image-bearing light 140 having a wavelength in the range of between 615 nm and 740 nm (e.g., red band). In an embodiment, the in-coupling diffractive optic 52, the intermediate diffractive optic 54, and the out-coupling diffractive optic 56 provide an optical path for image-bearing light 146 having a wavelength range between 450 nm and 485 nm (e.g., blue band).

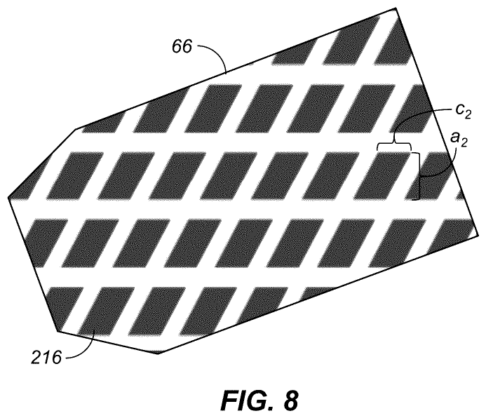

FIG. 7 is a front view of the second planar waveguide 22. In an embodiment, the in-coupling diffractive optic 60 includes diffractive features 210 having an associated grating vector k₉, and the in-coupling diffractive optic 62 includes diffractive features 212 having an associated grating vector k₆. The second intermediate diffractive optic 64 includes diffractive features 214 having an associated grating vector k₇, and the out-coupling diffractive optic 66 includes diffractive features 216 having associated grating vectors k₈ and k₁₀. In an embodiment, the out-coupling diffractive optic 66 includes a compound pattern of periodic diffractive features 216. The compound pattern may be represented by at least two grating vectors k₈, k₁₀. In an embodiment, as shown in FIG. 8, the diffractive features 216 have a length (a₂) of approximately 470 nm and a length (c₂) of approximately 490 nm. In an embodiment, the out-coupling diffractive optic 66 is arranged to provide pupil expansion in at least two directions.

Grating vectors, such as the depicted grating vectors k₆, k₇, k₈, k₉, and k₁₀ as shown in FIG. 7 extend in a direction that is normal to the respective diffractive features 210, 212, 214, 216 and have a magnitude related to the inverse to the period or pitch d of the diffractive features. The in-coupling diffractive optics 60, 62 and the intermediate diffractive optic 64 may each have a different period or pitch d. In one embodiment, the in-coupling diffractive optic 60 has a pitch of approximately 468 nm, the in-coupling diffractive optic 62 has a pitch of approximately 396 nm, and the intermediate diffractive optic 64 has a pitch of approximately 390 nm. In an embodiment, combinations of grating vectors ±k₆, ±k₇, and ±k₈ form a triangle when placed tip to tail. In one embodiment, the triangle is an equilateral triangle. In one embodiment, the triangle is an isosceles triangle. In one embodiment, the triangle is a scalene triangle. In an embodiment, the in-coupling diffractive optic 62, the intermediate diffractive optic 64, and the out-coupling diffractive optic 66 provide an optical path for the image-bearing light 144 having a wavelength in the range between 500 nm and 565 nm (e.g., green band). In an embodiment, the in-coupling diffractive optic 60 and the out-coupling diffractive optic 66 provide an optical path for image-bearing light 142 having a wavelength in the range of between 615 nm and 740 nm (e.g., red band).

One or more features of the embodiments described herein may be combined to create additional embodiments which are not depicted. The invention has been described in detail with particular reference to a presently preferred embodiment, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

What is claimed is:

1. An image light guide system for conveying a virtual image, comprising:
a first waveguide and a second waveguide, each of said first and second waveguides operable to propagate image-bearing light beams, said first and second waveguides each having first and second surfaces;
a first in-coupling diffractive optic formed along said first waveguide, wherein said first in-coupling diffractive optic is operable to diffract a first set of image-bearing light beams into said first waveguide in an angularly encoded form;
a second in-coupling diffractive optic formed along said first waveguide, wherein said second in-coupling diffractive optic is operable to diffract a second set of image-bearing light beams into said first waveguide in an angularly encoded form;
a first out-coupling diffractive optic formed along said first waveguide, wherein said first out-coupling diffractive optic is operable to expand at least a portion of said first and second sets of image-bearing light beams and direct said expanded image-bearing light beams from said first waveguide in an angularly decoded form;
a first intermediate diffractive optic formed along said first waveguide, wherein said first intermediate diffractive optic is operable to direct said second set of image-bearing light beams to said first out-coupling diffractive optic; and
a third in-coupling diffractive optic formed along said second waveguide, wherein said third in-coupling diffractive optic is operable to diffract a third set of image-bearing light beams into said second waveguide in an angularly encoded form.

2. The image light guide system of claim 1, further comprising a fourth in-coupling diffractive optic formed along said first surface of said second waveguide, wherein said fourth in-coupling diffractive optic is operable to diffract a fourth set of image-bearing light beams into said second waveguide in an angularly encoded form.

3. The image light guide system of claim 1, wherein said first set of image-bearing light beams comprises a first wavelength range and said second set of image-bearing light beams comprises a second wavelength range.

4. The image light guide system of claim 3, wherein said third set of image-bearing light beams comprises said first wavelength range.

5. The image light guide system of claim 4, wherein said first wavelength range is between 625 nm and 740 nm, wherein said second wavelength range is between 450 nm and 485 nm; and wherein said fourth set of image-bearing light beams comprises a third wavelength range, said third wavelength range between 495 nm and 570 nm.

6. The image light guide system of claim 1, further comprising a waveplate located between said first in-coupling diffractive optic and said third in-coupling diffractive optic, wherein said waveplate is operable to rotate a polarization of image-bearing light.

7. The image light guide system of claim 6, wherein said waveplate comprises a half-wave waveplate.

8. The image light guide system of claim 6, wherein said waveplate comprises a quarter-wave waveplate.

9. The image light guide system of claim 2, further comprising a second out-coupling diffractive optic formed along said second waveguide, wherein said second out-coupling diffractive optic is operable to expand at least a portion of said third and fourth sets of image-bearing light beams and direct said expanded image-bearing light beams from said second waveguide in an angularly decoded form.

10. The image light guide system of claim 9, further comprising a second intermediate diffractive optic formed along said second waveguide, wherein said second intermediate diffractive optic is operable to direct said fourth set of image-bearing light beams to said second out-coupling diffractive optic.

11. The image light guide system of claim 10, further comprising a material operable to block transmission of said second set of image-bearing light beams wherein the material is located optically between said second in-coupling diffractive optic and said second waveguide.

12. The image light guide system of claim 1, wherein said first in-coupling diffractive optic comprises a first plurality of diffractive features having a first periodicity, wherein said second in-coupling diffractive optic comprises a second plurality of diffractive features having a second periodicity, and wherein said second periodicity is different than said first periodicity.

13. The image light guide system of claim 1, wherein said first in-coupling diffractive optic is coaxial with said third in-coupling diffractive optic.

14. The image light guide system of claim 12, wherein said third in-coupling diffractive optic comprises a third plurality of diffractive features having a third periodicity, wherein said fourth in-coupling diffractive optic comprises a fourth plurality of diffractive features having a fourth periodicity, and wherein said fourth periodicity is different than said third periodicity.

15. The image light guide system of claim 6, further comprising an image source operable to generate a first wavelength range of image-bearing light beams, wherein said first wavelength range of image-bearing lights is incident upon said first in-coupling diffractive optic, said waveplate, and said third in-coupling diffractive optic.

16. The image light guide system of claim 11, wherein said material is located optically between said second in-coupling diffractive optic and said second intermediate diffractive optic.

17. The image light guide system of claim 10, wherein said first intermediate diffractive optic is partially overlapping said second intermediate diffractive optic.

18. An image light guide system for conveying a virtual image, comprising:
a first and a second waveguide, each of said first and second waveguides operable to propagate image-bearing light beams, said first and second waveguides each having first and second parallel surfaces, wherein said first parallel surface of said first waveguide is an inner surface facing said second waveguide, and wherein said first parallel surface of said second waveguide is an inner surface facing said first waveguide;
a first in-coupling diffractive optic formed along said inner surface of said first waveguide and disposed to direct image-bearing light beams into said first waveguide, wherein said first in-coupling diffractive optic comprises a first plurality of diffractive structures having a first periodicity and is operable to diffract at least a first part of a first portion of said image-bearing light beams into said first waveguide in an angularly encoded form,
a second in-coupling diffractive optic formed along said inner surface of said first waveguide and disposed to direct image-bearing light beams into said first waveguide, wherein said second in-coupling diffractive optic comprises a second plurality of diffractive structures having a second periodicity different from said first periodicity and is operable to diffract a second portion of said image-bearing light beams into said first waveguide in an angularly encoded form;
a first out-coupling diffractive optic formed along said inner surface of said first waveguide, wherein said first out-coupling diffractive optic is operable to expand said first portion and said second portion of said image-bearing light beams and direct said expanded first portion and said expanded second portion of said image-bearing light beams from said first waveguide in an angularly decoded form;
a first intermediate diffractive optic formed along said inner surface of said first waveguide and operable to direct said second portion of said image-bearing light beams to said first out-coupling optic; and
a third in-coupling diffractive optic formed along said first inner surface of said second waveguide and disposed to direct image-bearing light beams into said second waveguide, wherein said third in-coupling diffractive optic comprises a third plurality of diffractive structures having a third periodicity and is operable to diffract at least a second part of said first portion of said image-bearing light beams into said second waveguide in an angularly encoded form; and
a fourth in-coupling diffractive optic formed along said inner surface of said second waveguide and disposed to direct image-bearing light beams into said second waveguide, wherein said fourth in-coupling diffractive optic comprises a fourth plurality of diffractive structures having a fourth periodicity different from said third periodicity and is operable to diffract a third portion of said image-bearing light beams into said second waveguide in an angularly encoded form.

19. The image light guide system of claim 18, further comprising a waveplate located between said first in-coupling diffractive optic and said third in-coupling diffractive optic, and an absorptive layer located between said second in-coupling diffractive optic and said second intermediate diffractive optic, wherein said absorptive layer is operable to block image-bearing light.

20. The image light guide system of claim 18, further comprising a second out-coupling diffractive optic formed along said first surface of said second waveguide, wherein said second out-coupling diffractive optic is operable to expand said first and second parts of said first portion and said third portion of said image-bearing light beams and direct said expanded first and second parts of said first portion and said third portion of said image-bearing light beams from said second waveguide in an angularly decoded form.

21. The image light guide system of claim 20, further comprising a second intermediate diffractive optic operable to direct said third portion of said image-bearing light beams to said second out-coupling optic and located along said inner surface of said second waveguide.

22. The image light guide system of claim 1, wherein said first surface of said first waveguide is adjacent said second waveguide, and wherein said first surface of said second waveguide is adjacent said first waveguide.

23. The image light guide system of claim 22, wherein said first in-coupling diffractive optic, said second in-coupling diffractive optic, said first out-coupling diffractive optic, and said first intermediate diffractive optic are formed along said first surface of said first waveguide, and wherein said third in-coupling diffractive optic is formed along said first surface of said second waveguide, whereby said diffractive optics are located on inner surfaces of said first and second waveguides.
